(19) United States
(12) Patent Application Publication
(10) Pub. No.: US 2023/0101474 A1
(43) Pub. Date: Mar. 30, 2023

(54) APPARATUS AND COMPUTER-IMPLEMENTED METHOD FOR TRAINING A MACHINE LEARNING SYSTEM FOR MAPPING A SCAN STUDY TO A STANDARDIZED IDENTIFIER CODE

(71) Applicant: Siemens Healthcare GmbH, Erlangen (DE)

(72) Inventors: Pankaj KUMAR, Varanasi (IN); Nikhil LAKSHMAN, Bengaluru (IN)

(73) Assignee: Siemens Healthcare GmbH, Erlangen (DE)

(21) Appl. No.: 17/953,504

(22) Filed: Sep. 27, 2022

(30) Foreign Application Priority Data
Sep. 29, 2021 (DE) 10 2021 210 920.9

(51) Int. Cl. G06N 20/00; G06K 9/62; G06N 3/02

(52) U.S. Cl. CPC G06N 20/00; G06K 9/6256; G06K 9/6218; G06N 3/02

(57) ABSTRACT

Active learning is used to control which scan studies are to be mapped by a user. This control is utilized to prompt for labeling of the relatively difficult data points for a machine learning system in its current state of training. A number of techniques of mining knowledge from the scan studies and for determining optimal decision criteria are also provided.

### CROSS-REFERENCE TO RELATED APPLICATION(S)

The present application claims priority under 35 U.S.C. § 119 to German Patent Application No. 10 2021 210 920.9, filed Sep. 29, 2021, the entire contents of which are incorporated herein by reference.

### FIELD

One or more example embodiments of the present invention relate to mapping scan studies, which are usually designated by tenant-specific or manufacturer-specific protocols designations to a standardized identifier code dictionary such as the RadLex Playbook and the RadLex IDs (RPIDs) therein. One or more example embodiments of the present invention also provide a computer-implemented method for mapping scan studies, a computer program product, a data storage medium and a data stream related thereto.

### BACKGROUND

The naming of imaging procedures is currently not standardized across different countries or even different institutions. This impedes efforts to compare different types of scanned procedures and to establish national or international registries, for example of applies doses.

The Radiological Society of North America (RSNA) has developed the so-called RadLex playbook which is a reference for mapping is the effort towards addressing this gap. The RadLex playbook is available at the URL: http://playbook.radlex.org/playbook/SearchRadlexAction currently in its version 2.5 of February 2018. It shall, however, be understood that also later version of the RadLex playbook are included when the RadLex playbook is mentioned herein.

In the RadLex playbook, each scan study is mapped to a standardized identifier code SIC which in this case is termed a “RadLex ID” or “RPID” for short. RPID mapping is useful for standardizing the imaging procedures, for comparing similar procedures and studies across several regions and for facilitating including the dose and radiation managements across different institutions. In this way, also false alerts may be reduced in frequency or eliminated entirely.

The task of RPID prediction of a scan study (i.e. of mapping the scan study to an RPID) depends on many factors including modality, body region, study description, and much more. Manual mapping of such records occurring in thousands of exams per day is a cumbersome job for the radiologists.

It is generally known that machine learning systems, MLS, can automate some tasks that involve considerable effort for humans if they follow patterns which the MLS is trained to discern and recognize. However, training an MLS also requires a large amount of labelled data in order to perform supervised learning which is the most promising training method to date. In supervised learning, a training set of input data is provided, each item of input data being provided together with a label which indicates the correct, i.e. desired, output of an MLS for said input data.

### SUMMARY

The inventors have identified a need for systems and methods for training MLSs using a minimum amount of labels.

It is an object of one or more example embodiments of the present invention to provide systems and methods for training machine learning systems using a minimum number of labels.

Accordingly, according to a first aspect, an apparatus for training a machine learning system, MLS, for mapping a scan study to a standardized identifier code, SIC, of a standardized identifier code dictionary, SICD, is provided, the apparatus comprising:

an input interface configured to obtain a base set of scan studies, BSSS; and
a computing device configured to implement at least a clustering module configured to classify, using a clustering algorithm, the scan studies of the base set of scan studies, BSSS, into a plurality of clusters; and
an active learning module configured to train the machine learning system, MLS, the active learning module comprising:
a labelling task determining module, LTDM, configured to select at least one scan study from each cluster;
a labelling module configured to obtain SIC labels for the selected scan studies in order to generate a training set of labelled scan studies, TSLSS; and
a machine learning system training module, MLSTM, configured to train the machine learning system, MLS, based on the generated training set of labelled scan studies, TSLSS;
wherein the active learning module is further configured to re-train the machine learning system, MLS, by performing at least one refinement loop comprising:
determining, based on an evaluation metric, an additional set of scan studies to be labelled out of the base set of scan studies, BSSS;
obtaining SIC labels for the scan studies in the determined additional set of scan studies in order to enlarge the TSLSS;
re-training the MLS using at least the enlarged TSLSS.

Selecting scan studies out of the base set of scan studies, BSSS, to be labelled, shall be understood to mean that a true subset of the base set is selected. Preferably, the initial selection comprises at most 100 scan studies, preferably at most 50 scan studies. More preferably, the additional set of scan studies determined during each of the refinement loops is smaller than the set of scan studies selected in the initial selection, and may number for example 20 or less scan studies, preferably 10 scan studies.

The evaluation metric (which may also be designated as a selection criterion) is preferably based on an entropy of the scan study and/or on a position of a data point representing the scan study in the data point space used for the clustering. In this way, the evaluation metric may be used to determine such scan studies for additional labelling which are expected to most improve the accuracy of the machine learning system, MLS. Such scan studies may be scan studies that lie directly at or in around a cluster border.

The entropy of scan studies may additionally or alternatively also be determined based on the unigrams that they contain (essentially the text comprised in the scan study features). Another term for “unigram” is “1-gram”, wherein a 1-gram is a subtype of an n-gram (for any positive integer n), wherein an n-gram is a contiguous sequence of n items (e.g., phonemes, syllables, letters, words) from a given sample of text. Instead of the word “unigram”, also the words “elements”, “text elements” or “basic elements” can be used. For example, it can be determined how distinctive the unigrams in the scan study are overall by determining representations for different SICs based on unigrams. From there it can be determined whether a certain unigram has a comparatively higher entropy, i.e., is more uniformly present in and important for all representations, or whether the certain unigram has a comparatively lower entropy, i.e., is present in fewer representations.

The highest entropy may be assigned to a unigram that is present in each representation with the same weight such that it carries zero information for the labelling. The lowest entropy may be assigned to a unigram that is only present in a single representation (and possibly even with the highest weighting of all unigrams therein) such that there is a high chance that a scan study having said unigram should be classified to the SIC represented by that single representation. The entropy of a scan study may then be determined by the sum of the entropies of its unigrams, wherein the sum may be a weighted or an equal-weighted sum.

The mechanism (described in the following) for boosting or lowering the weights of unigrams in the representations based on the obtained labels then may contribute to changing the entropy of the unigrams. Moreover, it is evident that scan studies with high entropy will, as a tendency, be more difficult to classify automatically such that the training of the machine learning system, MLS, is expected to benefit most from the labelling of high entropy scan studies.

One or more example embodiments of the present invention utilize a so-called active learning approach (or: an active learning model), helping a user to label a minimum amount of scan studies to achieve a desired result. The evaluation metric (or: selection criterion), preferably based on entropy, improves the chances that the labels that are obtained (preferably by a user) are the ones that improve the machine learning system, MLS, the most.

The computing device may be realized as any device, or any means, for computing, in particular for executing a software, an App or an algorithm. For example, the computing device may comprise at least one processing unit such as at least one central processing unit, CPU, and/or at least one graphics processing unit, GPU, and/or at least one field-programmable gate array, FPGA, and/or at least one application-specific integrated circuit, ASIC, and/or any combination of the foregoing.

The computing device may further comprise a working memory operatively connected to the at least one processing unit and/or a non-transitory memory operatively connected to the at least one processing unit and/or a working memory. The computing device may be realized as a local device, as a remote device (such as a server connected remotely to a client with a user interface) or as a combination of these. A part, or all, of the computing device may also be implemented by a cloud computing platform. The input module and/or the output module may also be integrated into the computing device.

Although, here, in the foregoing and also in the following, some functions are described as being performed by modules, it shall be understood that this does not necessarily mean that such modules are provided as entities separate from one another. In cases where one or more modules are provided as software, the modules may be implemented by program code sections or program code snippets, which may be distinct from one another but which, may also be interwoven or integrated into one another.

Similarly, in cases where one or more modules are provided as hardware, the functions of one or more modules may be provided by one and the same hardware component, or the functions of several modules may be distributed over several hardware components, which need not necessarily correspond to the modules. Thus, any apparatus, system, method and so on which exhibits all of the features and functions ascribed to a specific module shall be understood to comprise, or implement, said module. In particular, it is a possibility that all modules are implemented by program code executed by the computing device, for example a server or a cloud computing platform.

According to a second aspect of the present invention, computer-implemented method for training a machine learning system for mapping a scan study to a standardized identifier code, SIC, of a standardized identifier code dictionary, SICD, is provided. The method comprises steps of:
obtaining a base set of scan studies, BSSS;
classifying, using a clustering algorithm, the scan studies of the base set of scan studies, BSSS, into a plurality of clusters;
selecting at least one scan study from each cluster;
obtaining SIC labels for the selected scan studies in order to generate a training set of labelled scan studies, TSLSS;
training a machine learning system, MLS, using the labelled scan studies to map individual scan studies to a corresponding SIC of the SICD;
performing at least one refinement loop comprising:
determining an additional set of scan studies out of the base set of scan studies, BSSS, based on an evaluation metric;
obtaining SIC labels for the scan studies in the determined set of scan studies in order to enlarge the training set of labelled scan studies, TSLSS;
re-training the machine learning system, MLS, using at least the enlarged training set of labelled scan studies, TSLSS.

It shall be understood that the method according to the second aspect of the present invention can be performed using the apparatus according to the first aspect of the present invention. Thus, the apparatus may be adapted, modified or refined based on any option, modification, variant or refinement described for the method and vice versa.

According to a third aspect, the present invention provides a computer program product comprising executable program code configured to, when executed, perform the method according to any embodiment of the second aspect of the present invention.

According to a fourth aspect, the present invention provides a non-transient or non-transitory computer-readable data storage medium comprising executable program code configured to, when executed, perform the method according to any embodiment of the second aspect of the present invention.

The non-transitory computer-readable data storage medium may comprise, or consist of, any type of computer memory, in particular semiconductor memory such as a solid-state memory. The data storage medium may also comprise, or consist of, a CD, a DVD, a Blu-Ray-Disc, an USB memory stick or the like.

According to a fifth aspect, the present invention provides a data stream representing, or configured to provide, program code configured to, when executed, perform the method according to any embodiment of the second aspect of the present invention.

According to a sixth aspect, the present invention provides a use of a machine learning system, MLS, trained using the method according to any embodiment of the second aspect of the present invention, for mapping a scan study to a standardized identifier code, SIC, in particular to a RadLex ID, RPID.

Here and in the following, for some (especially longer) terms abbreviations (such as “CNN” for “convolutional neural network”) are used. Usually, the terms will be given followed by the corresponding abbreviations. In some cases, to improve legibility, only the abbreviation will be used, whereas in other cases only the term itself will be used.

One or more functions, method steps, or modules, may be implemented or executed by a cloud computing platform. In systems based on cloud computing technology, a large number of devices is connected to a cloud computing system via the Internet. The devices may be located in a remote facility connected to the cloud computing system. For example, the devices can comprise, or consist of, equipment, sensors, actuators, robots, and/or machinery in an industrial set-up(s). The devices can be medical devices and equipment in a healthcare unit. The devices can be home appliances or office appliances in a residential/commercial establishment.

The cloud computing system may enable remote configuring, monitoring, controlling, and maintaining connected devices (also commonly known as ‘assets’). Also, the cloud computing system may facilitate storing large amounts of data periodically gathered from the devices, analyzing the large amounts of data, and providing insights (e.g., Key Performance Indicators, Outliers) and alerts to operators, field engineers or owners of the devices via a graphical user interface (e.g., of web applications). The insights and alerts may enable controlling and maintaining the devices, leading to efficient and fail-safe operation of the devices. The cloud computing system may also enable modifying parameters associated with the devices and issues control commands via the graphical user interface based on the insights and alerts.

The cloud computing system may comprise a plurality of servers or processors (also known as ‘cloud infrastructure’), which are geographically distributed and connected to each other via a network. A dedicated platform (hereinafter referred to as ‘cloud computing platform’) is installed on the servers/processors for providing above functionality as a service (hereinafter referred to as ‘cloud service’). The cloud computing platform may comprise a plurality of software programs executed on one or more servers or processors of the cloud computing system to enable delivery of the requested service to the devices and its users.

One or more application programming interfaces (APIs) are deployed in the cloud computing system to deliver various cloud services to the users.

Additional advantageous refinements, variants and options of and for the embodiments described in the foregoing are evident from the depending claims as well as from the following description together with the attached drawings.

In some advantageous embodiments, refinements, or variants of embodiments, of the apparatus according to the present invention, the labelling module is configured as a human machine interaction module, HMIM, configured to display scan studies selected by the labelling task determining module, LTDM, to a user as labelling tasks using a graphical user interface, and to obtain labels for the selected and displayed scan studies as responses by the user to the labelling tasks. In this way, a guided human-machine interaction is provided which harnesses the labelling skills of the user in a most efficient way.

In some advantageous embodiments, refinements, or variants of embodiments, the machine learning system, MLS, comprises a protocol determining artificial neural network, PDANN, configured to determine, for a scan study, a protocol name with which the scan study can be designated, and wherein the machine learning system comprises the PDANN. The protocol name is a (usually ordered) list of tokens or unigrams, i.e. of words and/or abbreviations expressed by letters and/or numbers which is used to identify, or designate, a particular scan sequence as it is performed in a hospital or a research institution. Since scan studies (almost) always are provided with protocol names, a large number of training data for training such a PDANN are present without any additional steps needed.

In some advantageous embodiments, refinements, or variants of embodiments, of the method according to the present invention, the SIC labels are obtained by presenting, preferably using a graphical user interface, a user with labelling tasks for the selected scan studies and receiving the user's input as labels for the selected scan studies. This provides a simple an intuitive way for a user to label the scan studies. Presenting the labelling tasks may allow the user to view all of the details or features of the scan studies, e.g. its text entries, the images obtain with that scan study and/or the like.

In some advantageous embodiments, refinements, or variants of embodiments, additional virtual scan studies, or features thereof, are generated for the training of the machine learning system, MLS, based on vectorize operations performed on scan studies of the enlarged TSLSS. At least the final re-training (e.g., a re-training within a final refinement loop) of the machine learning system, MLS, is performed using the enlarged TSLSS and the additional virtual scan studies or the features thereof. In variants where the fulfilment of an abort criterion for the refinement loop is not known before the performing of the re-training, an additional re-training may be performed after the final refinement loop. In some sub-variants, during the refinement loop only the actually labelled scan studies are used, and only in the additional re-training after the final refinement loop the additional virtual scan studies or features thereof are used. In other variants, where the fulfilment of the abort criterion for the refinement loops is known before the re-training (e.g. a fixed number of refinement loops is reached), the final re-training may be the re-training within the last refinement loop.

Features of virtual scan studies can be understood to refer to values of nodes of at least one hidden layer of a part of the machine learning system, MLS. Thus, there may be no actual scan study that is inserted into the MLS but the provision of values for the at least one hidden layer has the same effect for the MLS as if a scan study had been input. Thus, features of a virtual scan study can be provided without a virtual scan study itself being provided.

In some advantageous embodiments, refinements, or variants of embodiments, additional virtual scan studies are generated by adding a noise to scan studies for which labels have been obtained. The noise may be added, for example, in the form of additional unigrams being added to the list of unigrams of the scan study. In this case, it is preferred that words are added that have been determined to have a comparatively low impact on the mapping of the scan studies. As an alternative, the noise may be added as numerical noise to features of a hidden layer of a part of the machine learning system, MLS. At least the final re-training (e.g., a re-training within a final refinement loop) of the machine learning system, MLS, is performed using the enlarged TSLSS and the additional virtual scan studies thereof. Options and variants regarding the final re-training have been described in the foregoing.

In some advantageous embodiments, refinements, or variants of embodiments, the method comprises generating representations for the SICs based on weighted unigrams. Among other uses, this allows determining the importance of unigrams for the representations which in turn may be used to determine an evaluation metric (or selection criterion) for selecting tasks to be labelled.

In some advantageous embodiments, refinements, or variants of embodiments, the generated representations for the SICs are updated at least once based on the obtained SIC labels.

In some advantageous embodiments, refinements, or variants of embodiments, the representations for the SICs are updated by changing the weights of the weighted unigrams within the representations based on a determination of how impactful an addition and/or deletion of each unigram is for the decision of whether a specific scan study is classified into a particular SIC.

In some advantageous embodiments, refinements, or variants of embodiments, the machine learning system, MLS, comprises a protocol determining artificial neural network, PDANN, configured to determine, for a scan study, a protocol name with which the scan study can be designated, and wherein the mapping of the scan study to the SIC by the MLS is partially, and at least indirectly, based on the output of the PDANN based on the scan study.

In some advantageous embodiments, refinements, or variants of embodiments, wherein the refinement loop is iterated until an abort criterion is fulfilled, wherein the abort criterion may comprise any or all of:

a predefined number of labels has been obtained;
a predefined number of iterations has been performed; and/or the performance of the re-trained machine learning system, MLS, no longer improves significantly above a certain threshold or remains constant after a certain threshold.

### BRIEF DESCRIPTION OF THE DRAWINGS

The present invention will be explained in greater detail with reference to exemplary embodiments depicted in the drawings as appended.

The accompanying drawings are included to provide a further understanding of the present invention and are incorporated in, and constitute a part of, this specification. The drawings illustrate the embodiments of the present invention and together with the description serve to explain the principles of the present invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

In the figures:

FIG. 1 shows a schematic block diagram illustrating an apparatus according to an embodiment of the first aspect of the present invention;

FIG. 2 shows a schematic flow diagram illustrating a method according to an embodiment of the second aspect of the present invention;

FIG. 3 shows a schematic block diagram illustrating a computer program product according to an embodiment of the third aspect of the present invention; and

FIG. 4 shows a schematic block diagram illustrating a data storage medium according to an embodiment of the fourth aspect of the present invention.

### DETAILED DESCRIPTION

Although specific embodiments have been illustrated and described herein, it will be appreciated by those of ordinary skill in the art that a variety of alternate and/or equivalent implementations may be substituted for the specific embodiments shown and described without departing from the scope of the present invention. Generally, this application is intended to cover any adaptations or variations of the specific embodiments discussed herein.

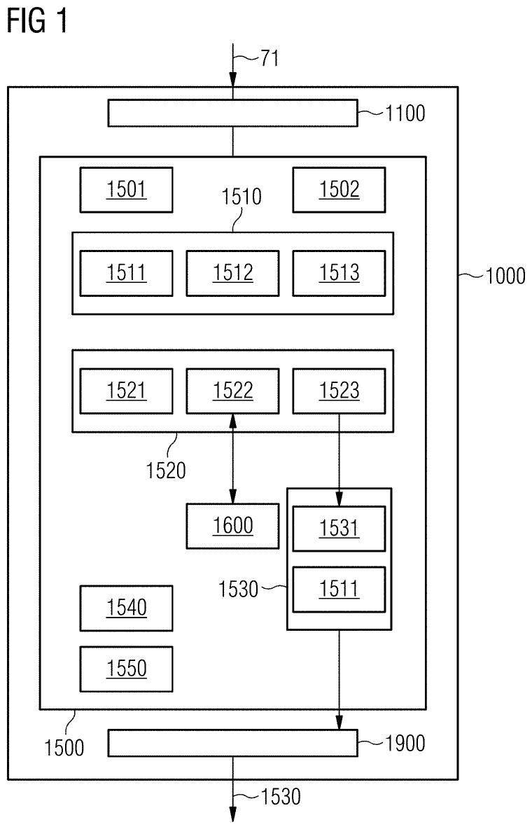

FIG. 1 shows a schematic block diagram illustrating an embodiment of the first aspect of the present invention, i.e. an apparatus 1000 for training a machine learning system, MLS 200, for mapping a scan study 71 to a standardized identifier code, SIC, of a standardized identifier code dictionary, SICD. For illustration, the RadLex playbook and its RPIDs will be used. However, it shall be understood that any other SICD may be used alternatively as well.

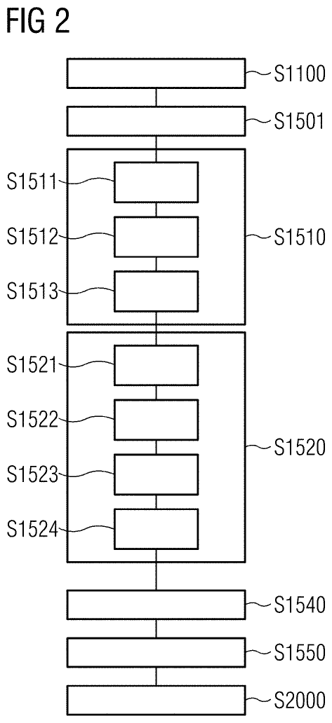

When describing the apparatus 1000 of FIG. 1, at the same time also a method according to an embodiment of the second aspect of the present invention will be described with respect to FIG. 2. It shall be understood that the method according to FIG. 2 can be performed using the apparatus 1000 according to FIG. 1. Thus, the apparatus 1000 may be adapted, modified or refined based on any option, modification, variant or refinement described for the method and vice versa.

FIG. 2 shows a schematic flow diagram illustrating a method according to an embodiment of the second aspect of the present invention, i.e. a method for training a machine learning system, MLS 200, for mapping a scan study 71 to a standardized identifier code, SIC, of a standardized identifier code dictionary, SICD. Although the method of FIG. 2 will be described together with the apparatus 1000 of FIG. 1 it shall be understood that the method of FIG. 2 is not restricted to being performed using the apparatus 1000, although this is a preferred variant.

The apparatus 1000 comprises an input interface 1100 configured to obtain a base set of scan studies, BSSS 71. Some of the scan studies of the base set of scan studies, BSSS 71, may be labelled, although for the present example it will be assumed that all scan studies are unlabeled. In the present context, labelled should be understood to mean that the scan study has been mapped correctly to a SIC, for example a RadLex Playbook ID, RPID. For the present discussion it will be assumed that a number of NM scan studies are comprised in the base set of scan studies, BSSS 71, and the individual scan studies of the base set of scan studies, BSSS 71, will be sometimes designated by sm, with the index m running from 1 to NM.

Accordingly, the method according to the present invention may comprise a step S1100 of obtain the base set of scan studies, BSSS 71, e.g. using the input interface 1100.

The apparatus 1000 further comprises a computing device 1500. The computing device 1500 may implement a preprocessing module 1501 configured to perform extracting and/or cleaning of data obtained, or received, via the input interface 1100, in particular the base set of scan studies, BSSS 71.

Accordingly, the method according to the present invention may comprise a step S1501 of preprocessing the base set of scan studies, BSSS 71, received in step S1100.

The scan studies may be represented as tuples (x, y, z), wherein x is a sub-vector consisting of a list of features, y is a protocol name indicating a protocol with which the scan study has been performed, according to the features x, and z are the image data acquired in the scan study. The features x may comprise, for example:

a study description
a series description
a maximum dose length product, maxDLP
maxCTDIVolume
a scan length
and/or the like.

The scan length sc can be derived from other features, in particular from maxDLP and maxCTDIVolume, by:

sc=(maxDLP/maxCTDIVolume)*100

The protocol is in the present context set of rules defined to perform an image acquisition procedure for acquiring a scan study. The protocol name is a (usually ordered) list of tokens or unigrams, i.e. of words and/or abbreviations expressed by letters and/or numbers. From the protocol names (and optionally in addition other text fields of the scan study features x) of all scan studies of the base set of scan studies, BSSS 71, a vocabulary can be created. The vocabulary can then be treated using natural language processing, NLP, techniques such as word embeddings and the like.

The protocol name is usually specific to manufacturers of scanning devices and/or to users such as hospitals or research institutions. The protocol name commonly includes a token or word that specifies a body area (e.g. “abdomen”), although different manufacturers or users may designate the same (or partially overlapping) body areas equally or differently. For example, the essentially same body region may in one protocol scheme used by a manufacturer A be designated as “head”, and in another protocol scheme used by a manufacturer B be designated as “brain”. As another example, even within one institution, one user (such as a physician or a scan technical assistant) may use the designation “head” and the other the designation “brain”. Each manufacturer may use, for the same body region, several protocols for the same type of examination differing according to the age of the patient, wherein between different manufacturers A, B different age groups may be defined.

The protocol name may also include a token indicating a type of scan having been performed and may include additional tokens optionally, for example indicating whether optional additional measures have been taken or not. For instance, the protocol may include an indication that a contrast agent has been administered or has not been administered.

The computing device 1500 is further configured to implement a clustering module 1510. The general purpose for the clustering module 1510 is clustering the scan studies of the base set of scan studies, BSSS 71, with the intention of later identifying, as much as possible, the clusters with SICs of the SICD.

Accordingly, the method according to the present invention may comprise a step S1510 of clustering the scan studies of the base set of scan studies, BSSS 71, as will be described in the following on the basis of a number of sub-steps of step S1510. All the functions that are described as part of the function of the clustering module 1510 may also be understood to be performed as part, or as sub-steps, of step S1510.

The clustering module 1510 may comprise a protocol-determining artificial neural network, PDANN 1511 (or, more specifically: a protocol-name-determining artificial neural network, PNDANN), which is preferably provided in form of a convolutional neural network, CNN. The PDANN 1511 may be configured to receive, as its input, at least a part of the features x of each study sm sm=(xm, ym, zm). For example, parts of x that are known to be of no consequence to the task at hand (for example timestamps) may not be part of the input.

The input may optionally also comprise the image data z, and also optionally data from image analysis tools that have performed an analysis of the image data z.

For the input of the PDANN 1511, all unigrams present in the features x may be grouped together into one data field, and the text content of each scan study may then be represented by a vector V with as many entries as the vocabulary has unigrams, and each entry indicates the quantity of unigrams within the scan study sm=(xm, ym, zm) associated with that vector. Usual count vectorizer techniques dealing with too frequent or too nondescript words may be applied. All of the vectors V may be used to form an NM×NV-dimensional matrix, with the number of scan studies and NV the number of unigrams in the vocabulary. The vector V(sm) may be designated as a “text vector of a scan study” because the vector V(sm) describes the text comprised in the scan study sm=(xm, ym, zm). The matrix with entries Tij, each given by the j-th entry of the text vector V(si)j of the i-th scan study si, max be designated as the text matrix of the BSSS 71.

The PDANN 1511 is further configured to output, based on its input, a vector U indicating with which probability the input should be associated with (or: classified to) which protocol (or, more precisely: which protocol name). This vector U may be designated as a protocol classification vector, PCV.

Accordingly, the method according to the present invention may comprise a step S1511 of generating, using a PDANN 1511, a vector U indicating with which probability the input should be associated with (or: classified to) which protocol name. Again, a matrix A can be generated with entries Aij given by the i-th entry of the vector Ui for the i-th scan study sj.

Accordingly, the method according to the present invention may comprise a step S1511 of generating, using a protocol-determining artificial neural network, PDANN 1511, a vector U indicating with which probability the input should be associated with (or: classified to) which protocol name out of a list of available protocols names, wherein the input of the PDANN 1511 is based on one of the scan studies sm such that the output vector U indicates to which protocol name the respective scan sm study should be classified.

Ideally, a list of available protocols may be stored in a memory 1502 of the computing device 1500, wherein each protocol is associated with an integer. This integer may correspond to an index (i.e. entry) of the output protocol classification vector U of the protocol-determining artificial neural network, PDANN 1511, which may be generated using a softmax activation function in the last layer. Thus, the output protocol classification vector U will have as many indices as there are available protocols in the list of available protocols. The output protocol classification vector U will have, in each entry with index i, a real number Pi indicating the likelihood that the input used by the PDANN 1511 for generating the output vector U should be associated with the protocol characterized by the integer i, wherein, due to the softmax activation function ΣiPi=1.

The protocol-determining artificial neural network, PDANN 1511, is preferably trained using the protocol names y of the scan studies sm as labels. The purpose behind this is training the PDANN 1511 to recognize which unigrams and features are best suited for determining the protocol name of a scan study. Based on this information, it can be inferred which unigrams are most important or contribute the most for the decision that a particular scan study belongs to a particular body region.

The method according to the present invention may therefore also comprise a step of training the PDANN 1511 in this manner.

The computing device 1500 is further configured to implement a protocol representation determining module, PRDAM 1512. The PRDAM 1512 is configured to determine a representation for each protocol, based on the base set of scan studies, BSSS 71.

Accordingly, the method according to the present invention may comprise a step S1512 of determining a representation for each protocol, based on the base set of scan studies, BSSS 71.

The representation is preferably a weighted sum of unigrams. For example, the representation of a certain protocol may indicate, for each unigram in the vocabulary, how impactful that unigram is for the decision of the PDANN 1511 to classify the scan study to that protocol.

The representation Bl for each protocol l may be determined in the following way:

The protocol-determining artificial neural network, PDANN 1511, has been trained, as has been described in the foregoing, to classify any of the scan studies into a protocol, using the protocol classification vector U. The protocol representation determining module, PRDAM 1512, is configured to modify the scan studies of the base set of scan studies, BSSS 71, and to determine, based on the changes this has on the output of the protocol-determining artificial neural network, PDANN 1511, the representation of each protocol.

A preferable implementation of this procedure will first be described at hand of a single scan study. Suppose that the scan study comprises text consisting of the unigrams (u1, u2, u3, u4). In other words, the text vector V(sm) of the scan study sm will have non-zero integer entries at indices corresponding to u1, u2, u3 and u4. The PRDAM 1512 will perform any or both of the following two steps (which may also be comprised in the method according to the present invention):

a) adding to this original text vector V(sm) single additional unigrams ui that are not present in the original text vector V in order to generate an amended text vector V+(sm,ui);
b) removing from this original text vector V single unigrams uj that are part of the original text vector V in order to generate an amended text vector V−(sm,uj).

Adding a unigram ui may be done by setting the entry with the index i in the original text vector V to “1”, and removing a unigram uj may be done by setting the entry with the index j in the original text vector V to “0”.

If both steps a) and b) are performed, this means that an amended text vector is generated for each of the unigrams in the vocabulary: the V+(sm,ui) treat the unigrams that are not part of the original text vector V, and the V−(sm,uj) treat the unigrams that are part of the original text vector V.

The amended text vectors V+(sm,ui) and/or V−(sm,uj) are then, one by one, input into the protocol representation determining module, PRDAM 1512, and the corresponding amended protocol classification vector U(V+(sm,ui)), U(V−(sm,uj)) is generated and compared to the original protocol classification vector U(V) of the original text vector.

For scan study and each protocol l, the difference in the probability Pl between the original protocol classification vector U(V) and the amended protocol classification vector U(V+(sm,ui)), U(V−(sm,uj)) is calculated:

δPl(m,ui):=U(V+(sm,ui))l−U(V(sm))l,

δPl(m,uj):=U(V−(sm,uj))l−U(V(sm))l,

wherein “:=” denotes a definition, and U(V)l is the l-th entry (i.e. entry with the index l) of the protocol classification vector U and U(V+(sm,ui))l is the l-th entry of the amended protocol classification vector U(V+(sm,ui)). It should be recalled that the l-th entry U(V)l of the protocol classification vector is the probability Pl that protocol l is the optimal description for a particular scan study.

In other words, δPl(m,ui) is a measure for how much the unigram ui impacts the probability that the scan study with index m is classified with protocol l.

An initial representation of each protocol l can then be generated by taking the weighted sum over each unigram, wherein each unigram is weighted with the entirety of the δPl(m,ui) for all scan studies m normalized by NM. If there are NL protocols in the list of available protocols, and each representation of a protocol is denoted with Bl, l ranging from 1 to NL, then:

$$B 1 = {\sum }_{i = 1}^{{N}_{V}} {u}_{i} {\sum }_{m = 1}^{{N}_{M}} \frac{δ {P}_{l} ( m , {u}_{i} )}{{N}_{M}}$$

This procedure will result in the representations of the protocols being characterized by how impactful, or in other words how characteristic, the individual unigrams are for the protocol. For example, a protocol l relating to a scan of a head may, in its representation Bl, exhibit comparatively higher weights for unigrams like “head”, “brain” etc. and comparatively lower weights for unigrams like “chest”, “abdomen”, or the like. As a side note, although in the machine learning field in many programming languages (such as Python—registered trademark) vectors and lists often start with the index “0”, herein the explanations are given using lists ranging from 1 . . . N. In an implementation using Python, such a list would be implemented with a vector with N entries, starting from entry 0 up to entry N−1, which is deemed to be less clear for the purposes of explanation.

The computing device 1500 is further configured to implement a clustering algorithm executing module, CAEM 1513, of the clustering module 1510. The clustering algorithm executing module, CAEM 1513, is configured to employ a k-means algorithm in order to cluster the scan studies, which may also be designated as records. The number NC of clusters that are sought may be given by the number of SICs in the SICD (e.g. by the number of RadLex IDs for body regions) or it may be determined (preferably dynamically) by an optimization algorithm, e.g. the elbow method. The elbow methods seeks to find a flattening-out, or “elbow”, in a graph representing distortion (sum of squared errors, SSE) as a function of the number of clusters.

The scan studies sm may be clustered according to any or all of their features or properties. As one advantageous example, the scan studies sm may be clustered based (e.g., only) on their text vectors V(sm) which will usually be sparse. Thus, each scan study me be represented by a point in an NV-dimensional space, and the clustering algorithm may seek to group these points into clusters.

Accordingly, the method according to the present invention may comprise a step S1513 of employing a k-means algorithm in order to cluster the scan studies, i.e. to classify the scan studies into NC clusters. Each cluster will be identified with an integer number c ranging from 1 to NC. Distances will be defined as distances of each studied point from a corresponding centroid (center of cluster), wherein the centroid is the mean position of all points in a cluster.

As a result of the clustering algorithm executing module, CAEM 1513, or, analogously, step S1513, now the base set of scan studies, BSSS 71, is clustered into NC clusters. Thus, each scan study may be augmented by two additional features:

1) its cluster number c according to the clustering (the cluster number c corresponding to an RPID in this case)
2) the distance of the point signifying (or: specifying, or: defining) the scan study to the centroid point of its cluster c.

At this point, when all of the scan studies are classified into one of the clusters, the active learning approach can start.

The computing device 1500 is further configured to implement an active learning module 1520. The active learning module 1520 is configured to train a machine learning system, MLS 1530, to map scan studies to the RPIDs. The machine learning system, MLS 1530, may comprises, or consists of, the protocol determining artificial neural network, PDANN 1511 (which is a specific convolutional neural network, CNN), and a classifier 1531 arranged after the PDANN 511 in the pipeline of the MLS 1530.

Training the MLS 1530 may in particular comprise, or consist of, training the classifier 1531. The MLS 1530 may comprise other modules or mathematical entities as described in the foregoing which may be used as input to the classifier 1531 and/or which may be used to generate input to the classifier 1531. For example, the MLS 1530 may comprise an entity based on the representations of the protocols or of the SICs, such as a matrix formed by taking each representation as a column (or each as a row). Each part of the MLS 1530 may or may not be trained by the active learning module 1520.

In order to train the machine learning system, MLS 1530, a comparatively small training set of labelled scan studies, TSLSS, will be prepared which will be augmented over several refinement loops for the active learning of the machine learning system, MLS 1530. One of the main ideas is that the TSLSS will be specifically and selectively augmented by such labelled scan studies that are deemed to be most helpful (or: most impactful) for improving the MLS 1530.

The training set of labelled scan studies will be generated and augmented by presenting labelling tasks for labelling a selection of scan studies to a user (e.g. a physician) and to receive, as response to the tasks, the selection together with SIC labels for each scan study therein. In the vernacular of active learning, the user can be designated as an “oracle” in this procedure.

Accordingly, the method according to the present invention may comprise a step S1520 of training a machine learning system, MLS 1530.

The active learning module 1520 may comprise a labelling task determining module, LTDM 1521, configured to—initially—randomly select one scan study from each of the clusters determined by the clustering module 1510 in order to generate a selection of NC scan studies to be labelled.

The labelling module 1520 may further comprise a labelling model configured to obtain labels for the selection of NC scan studies to be labelled. Since it is preferred that the labels are obtained from a human user, the labelling module is herein also referred to as a human machine interaction module, HMIM 1522, operatively connected to a user interface, preferably a graphical user interface, GUI, implemented by a display device 1600. The HMIM 1522 is configured to present, using the GUI, labelling tasks to a user and to receive, using the GUI, a response by the user to the labelling tasks (i.e. the labels). Scan studies which have been provided with a label are denoted in the following as smL. The display device 1600 may or may not be part of the apparatus 1000. The presentation of (and response to) the labelling tasks may happen in real time, or in a time-delayed manner.

Accordingly, the method according to the present invention may comprise a step S1521 in which from each of the clusters determined by the clustering step S1510 one scan study in order is selected at random in order to generate a selection of NC scan studies to be labelled.

The display device 1600 may be, for example, a monitor, a touchscreen, a virtual reality system, an augmented reality system, a holographic system, a projector or the like.

In a step S1522, the labelling task with the selection of scan studies to be labelled is presented to a user, preferably using a graphical user interface implemented by a display device 1600.

In a step S1523, the response of the user to the labelling tasks, i.e. the labels for the scan studies in the selection of scan studies, is received, preferably again via the graphical user interface, GUI.

These initially labelled scan studies smL obtained by the labelling module, 1520 (or by the step S1520) form the first part of a training set of labelled scan studies, TSLSS. This initial TSLSS will be enlarged in further steps. At the present stage, in a step S1524, the machine learning system, MLS 1530, will be trained using the current TSLSS.

Thus, the computing device 1500 is configured to implement a machine learning system training module, MLSTM 1523, configured to train the machine learning system, MLS 1530, on the current training set of labelled scan studies, TSLSS.

Another result is that now, as a first approximation, all of the scan studies belong to the same cluster as each of the initially labelled scan studies smL can be deemed to belong to have the same label. Since one scan study of each cluster has been labelled, there are now NC labelled scan studies smL and NM-NC scan studies that have labels by inference, i.e. by virtue of their belonging to the same cluster as one of the labelled scan studies smL. This is sometimes designated as “label propagation” and comprises a transfer of knowledge from the scan studies labelled directly by the user to the remaining scan studies in order to create an enlarged training set. For some applications, this enlarged training set may already be sufficiently accurate to perform supervised training.

As an example, the user may have labelled a particular scan study smL with the RPID (RadLex ID, as one type of SIC) of RPID64. The human machine interaction module, 1522, may be configured such as to provide the user, via the GUI, with a convenient drop-down menu (or other type of selection from a given set of answers) including the RPID codes.

The memory 1502 of the computing device 1500 may further comprise a table wherein each of the selectable RPID codes is linked to a text-based description thereof. For example, according to the RadLex playbook, the RPID64 is associated with (or linked to) the “Long Description” of “CT Pelvis Cystogram wo IV Contrast”. From this, such unigrams or tokens as “CT” (“computed tomography”), “Pelvis”, “Cystogram”, “wo IV Contrast” (“without intravenous contrast”) may be extracted.

Since the user has, in response to the labelling task, provided an RPID for each of the scan studies smL selected for labelling, a scan study smL has been selected for each of the determined clusters, this means that now each cluster can be associated with an RPID. Instead of representations Bl of body regions, one can therefore speak of representations Qc of RPIDs (or, in general, of representations of SICs).

The computing device 1500 further implements a weighting updating module 1540 configured to update the weights of the unigrams in the representations Qc of the clusters c depending on the response to the labelling task. The text vector V(smL) for a labelled study smL can be analyzed with regard to whether the unigrams linked with the label (here: RPID64) are present in the representation Qc of the clusters c to which the labelled study smL has been previously classified. For unigrams that are present, their weights are boosted for the representation Qc of the clusters c, while their weights for the representations Qd of other clusters d≠c are reduced.

If the user uses (for example, among others) a new unigram that has not yet been included in the vocabulary for labelling a scan study, then the vocabulary may be expanded and the count vectorizer value for text vectors V for the labelled scan study will be set to “1”. If the user uses one or more unigrams that are already present in the text vector V, their value (i.e. their numeric entry within the text vector V) may be increased. The increase may be determined as a percentage, for example a fixed percentage between 20% and 70%, preferably between 30% and 60%, most preferably 50%. The increase may also be determined as an absolute value, for example by a value between 0.2 and 0.7, preferably between 0.3 and 0.6, most preferably 0.5.

Accordingly, the method according to the present invention may comprise a step S1540 of updating the weights of the unigrams in the representations Qc of the clusters c depending on the response to the labelling task in the way described above.

A clustering updating module 1550, may be implemented by the computing device 1500, the clustering updating module 1550 being configured to update, if necessary, the number NC of clusters c and the distances of the data points representing the scan studies to the respective centroids. For example, it is conceivable that two scan studies originally belonging to two clusters generated based on the number of protocols 1 have been labelled by the user to actually belong to the same RPID. Then the two original clusters representing two different protocols 1 can be merged to one cluster representing a single RPID. The number of clusters NC is thus reduced by one, the centroid for the new cluster will be different from the centroids of the two previous clusters, and the distances of the scan studies belonging to the new cluster will also be updated since they will in general be different from their previous distance to the respective nearer centroid of the two previous clusters.

Accordingly, the method according to the present invention may comprise a step S1550 of updating the number and shape of clusters and/or the distances of the scan studies to the centroid of the cluster to which they belong. The re-clustering S1550 by the clustering updating module 1550 may be performed during the active learning approach performed by the active learning module 1520 (e.g. during a refinement loop) or thereafter, e.g. in preparation for a later re-training of the machine learning system, MLS 1530.

In a so-called refinement loop, at least the steps of selecting scan studies to be labelled by the user (i.e. determining labelling tasks S1521, presenting labelling tasks 1522, obtaining the labels S1523, and re-training S1524 (or, in the refinement loop: re-training) the machine learning system, MLS 1530, are repeated. Each repetition of this refinement loop will increase the number of labelled scan studies smL and will evidently also further improve the MLS 1530.

After the first batch of scan studies to be labelled (one from each of the original clusters) is selected, in each iteration f of the refinement loop another NS(f) scan studies are selected for labelling. The number NS can be different for each iteration f but will be fixed in the example described herein. The number NS is preferably lower than the number Nc of protocols and/or lower than the number of SICs (here: RPIDs) and may, for example, be between 5 and 30, preferably between 15 and 20. In the present example, the setting is NS=10.

At the beginning of iteration f, the scan studies that have not been labelled by a user yet number NM−NC−(f−1)*NS. From these, again NS will be selected. One possible procedure is that first from the unlabeled scan studies, the d*NS scan studies with the highest entropy are selected, and from these again then NS are finally selected to be labelled. The integer d may be any number, for example between 1 and 10, and is here set to 5.

The selection of the NS scan studies within the initially selected d*NS scan studies can be made according to any criterion, e.g. again the highest entropy. For example, it is advantageous to determine the unigrams ui with the highest variance over its weights within the representations Qc, i.e. that are, in other words, highly distinctive regarding the representations Qc. In order to understand this, one may consider a unigram ui that has the same weight in each representation Qc; such a unigram ui would have variance zero and would have carry essentially no indication for any of the representations Qc. Then, from the initially selected d*NS scan studies, the NS scan studies can be selected that comprise unigrams with the highest total variance, with the additional condition that no scan study is selected that has already been labelled.

The iteration of the refinement loop can be performed until an abort criterion is reached. The abort criterion may be, for example:

a predefined number of scan studies sent to the user for labelling is reached, the number being preferably between 100 and 400, more preferably between 200 and 300;
predefined number of iterations (i.e. the number of times that the machine learning system, MLS 1530, is re-trained);
when the performance of the MLS 1530 no longer improves significantly above a certain threshold or remains constant after a certain threshold.

It may also be determined that the refinement loop is aborted when at least a predefined number of scan studies are selected in a refinement iteration f that have already been selected in a previous refinement iteration f. Since the pre-selection of the d*NS scan studies is based on entropy, such a re-selection of the same scan studies indicates that the entropy even for the scan studies with the highest entropy can no longer be reduced by labelling.

Such a refinement loop may be employed again in the future as a feedback, for example in case the performance of the machine learning system, MLS, decreases. In that case, the machine learning system, MLS, may automatically be re-trained again in one or more refinement loop(s) as described in the foregoing.

After the refinement loops are finished, optionally more data can be synthesized for further increasing the size of the training data set.

One option is to keep the protocol determining artificial neural network, PDANN 1511, constant and create additional virtual scan studies sV(sm, δV) by adding, to at least one existing scan study sm, a noise δV by insertion or deletion of unigrams to/from the text vector V(sm), wherein preferably such unigrams are selected that have little impact on the classification of the scan studies into SICs. For example, the unigram “topogram” does not relate to any specific body region. In order to determine the impact, a chi-squared-test can be applied. Then, in cases where the MLS 1530 comprises the PDANN 1511 and the classifier 1531 taking the output of the PDANN 1511 as its input, the classifier 1531 can be trained using—among others—the additional virtual scan studies sV(sm, δV) together with the label that was given by the user to the original scan study sm to which the noise δV was added.

Another option is to use vectorization, i.e. a process of generating additional vectors using vector operational conditions.

For example, if a scan studies s1 is labelled with an RPID indicating the abdomen as body region, and a scan study s2 is labelled with an RPID indicating the pelvis as body region, then the vector addition s1+s2 can be used to generate a new virtual scan study labelled with an RPID indicating abdomen+pelvis as body region. Similarly, vector subtraction s3−s4 can be used to generate hidden layers of virtual studies relating to a smaller body region or to less body regions than the one with which s3 has been labelled. The addition and/or deletion may be performed on the entire features x of the studies and/or on intermediate layers of the protocol determining artificial neural network, PDANN 1511 based on the scan studies s1, s2, s3 and s4, respectively. In the latter case, the hidden layers of the virtual studies may be inserted into the PDANN 1511, for its training at the level (i.e. instead) of the respective intermediate layers, while the actual scan studies are still input into the PDANN 1511, at its first layer, i.e. its input nodes.

Eventually, the final training of the MLS 1530 can be based on any or all of:

all of the labelled scan studies smL from the initial labelling as well as from the iterations of the refinement loop;
all of the additional virtual scan studies;
other scan studies labelled by label spreading, i.e. labelled by the label that has been given to labelled scan studies smL of the same cluster,

wherein the options are enumerated starting with the most reliable (and most preferable) and ending with the least reliable.

As a result, an enormous amount of training data is available for training the MLS 1530, to accurately determine the SIC (here: RPID) of any scan study, although actually only a comparatively very small number of scan studies have had to be labelled by a user. Moreover, the time and effort of the user labelling the data was used extremely efficiently, as the user was given labelling tasks that were poised to maximally improve the MLS 1530. The apparatus 1000 further comprises an output interface 1900 configured to output the trained MLS 1530. Both the input interface 1100 and/or the output interface 1900 may be realized in hardware and/or software, wire-bound or wireless and may in particular be connected to a network such as an intranet or the Internet.

In the deployment phase, the trained machine learning system MLS 1530 may be used to determine the RPID for a previously unknown scan study, i.e. to map the scan study to an RPID.

Thus, a method according to the present invention may also comprise a step S2000 of using the trained MLS 1530 to determine the RPID for a previously unknown scan study. Such a method, which may or may not comprise the steps for training the MLS 1530 described in the foregoing, may be designated as a method for mapping a scan study to a SIC of an SICD.

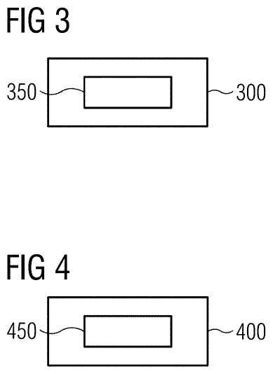

FIG. 3 shows a schematic block diagram illustrating a computer program product 300 according to an embodiment of the third aspect of the present invention. The computer program product 300 comprises executable program code 350 configured to, when executed, perform the method according to the present invention, in particular as it has been described in the foregoing with respect to FIG. 1 and FIG. 2.

FIG. 4 shows a schematic block diagram illustrating a non-transitory, computer-readable data storage medium 400 according to an embodiment of the third aspect of the present invention. The data storage medium 400 comprises executable program code 450 configured to, when executed, perform the method according to the present invention, in particular as it has been described in the foregoing with respect to FIG. 1 and FIG. 2.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents. Many other examples will be apparent to one skilled in the art upon reviewing the above specification.

The embodiments were chosen and described in order to best explain the principles of the present invention and its practical applications, to thereby enable others skilled in the art to best utilize the present invention and various embodiments with various modifications as are suited to the particular use contemplated.

In brief words, again, one of the main ideas of the present invention is to use active learning to control which scan studies are to be mapped by a user. This control is utilized to prompt the user to label the—for the MLS 1530 in its current state of training—most difficult data points. It has been found by the inventors that in this way the time and effort for a user to map records is reduced while providing, at the same time, better prediction performance. The present invention also provides a number of techniques of mining knowledge from the scan studies and for determining optimal decision criteria.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the present invention has been shown and described with respect to certain example embodiments, equivalents and modifications will occur to others skilled in the art upon the reading and understanding of the specification. The present invention includes all such equivalents and modifications and is limited only by the scope of the appended claims.

What is claimed is:

1. An apparatus for training a machine learning system for mapping a scan study to a standardized identifier code of a standardized identifier code dictionary, the apparatus comprising:
an input interface configured to obtain a base set of scan studies;
a computing device configured to implement at least a clustering module to classify, using a clustering algorithm, scan studies in the base set of scan studies into a plurality of clusters; and
an active learning module configured to train the machine learning system, the active learning module including
a labelling task determining module configured to select at least one scan study from each cluster among the plurality of clusters,
a labelling module configured to obtain standardized identifier code labels for the selected scan studies in order to generate a training set of labelled scan studies, and
a machine learning system training module configured to train the machine learning system based on the training set of labelled scan studies;
wherein the active learning module is further configured to re-train the machine learning system by performing at least one refinement loop, the at least one refinement loop including
determining, based on an evaluation metric, an additional set of scan studies to be labelled, from the base set of scan studies,
obtaining standardized identifier code labels for scan studies in the additional set of scan studies in order to enlarge the training set of labelled scan studies, and
re-training the machine learning system using at least the enlarged training set of labelled scan studies.

2. The apparatus of claim 1, wherein the labelling module is a human machine interaction module configured to
display the scan studies selected by the labelling task determining module to a user as labelling tasks using a graphical user interface, and
obtain labels for the selected and displayed scan studies as responses by the user to respective labelling tasks.

3. The apparatus of claim 1, wherein the machine learning system comprises:
a protocol determining artificial neural network configured to determine, for a scan study, a protocol name with which the scan study is to be designated.

4. A computer-implemented method for training a machine learning system for mapping a scan study to a standardized identifier code of a standardized identifier code dictionary, the computer-implemented method comprising:
obtaining a base set of scan studies;
classifying, using a clustering algorithm, scan studies in the base set of scan studies, into a plurality of clusters;
selecting at least one scan study from each cluster among the plurality of clusters;
obtaining standardized identifier code labels for the selected scan studies in order to generate a training set of labelled scan studies;
training a machine learning system, using the labelled scan studies to map individual scan studies to a corresponding standardized identifier code of the standardized identifier code dictionary;
performing at least one refinement loop including
determining, based on an evaluation metric, an additional set of scan studies from the base set of scan studies,
obtaining standardized identifier code labels for scan studies in the additional set of scan studies in order to enlarge the training set of labelled scan studies, and
re-training the machine learning system, using at least the enlarged training set of labelled scan studies.

5. The method of claim 4, wherein the standardized identifier code labels are obtained by presenting, using a graphical user interface, a user with labelling tasks for the selected scan studies and receiving user input as labels for the selected scan studies.

6. The method of claim 4, wherein additional virtual scan studies, or features thereof, are generated for training the machine learning system based on vectorize operations performed on scan studies of the enlarged training set of labelled scan studies, and wherein at least a final re-training of the machine learning system is performed using the enlarged training set of labelled scan studies and the additional virtual scan studies or the features thereof.

7. The method of claim 4, wherein additional virtual scan studies are generated by adding noise to scan studies for which labels have been obtained, and wherein at least a final re-training of the machine learning system is performed using the enlarged training set of labelled scan studies and the additional virtual scan studies.

8. The method of claim 4, further comprising:
generating representations for standardized identifier codes based on weighted unigrams.

9. The method of claim 8, wherein the representations for the standardized identifier codes are updated at least once based on the standardized identifier code labels.

10. The method of claim 9, wherein the representations for the standardized identifier codes are updated by changing weights of the weighted unigrams within the representations based on a determination of how impactful at least one of an addition or a deletion of each weighted unigram is for deciding whether a specific scan study is classified into a particular standardized identifier code.

11. The method of claim 4, wherein the machine learning system includes a protocol determining artificial neural network configured to determine, for a scan study, a protocol name with which the scan study is to be designated, and wherein the mapping of the scan study to the standardized identifier code by the machine learning system is partially, and at least indirectly, based on an output of the protocol determining artificial neural network.

12. The method of claim 4, wherein the refinement loop is iterated until an abort criterion is fulfilled, and wherein the abort criterion includes at least one of
a threshold number of labels has been obtained,
a threshold number of iterations has been performed, or
performing of the re-training of the machine learning system no longer improves significantly above a certain threshold or remains constant after a certain threshold.

13. A method for mapping a scan study to a standardized identifier code of a standardized identifier code dictionary, the method comprising:
using a machine learning system trained using the method according to claim 4 to map the scan study to the standardized identifier code of the standardized identifier code dictionary.

14. A non-transitory computer program product comprising executable program code that, when executed by at least one processor, causes the at least one processor to perform the method according to claim 4.

15. A non-transitory computer-readable storage medium including executable program code that, when executed by at least one processor, causes the at least one processor to perform the method according to claim 4.

16. The apparatus of claim 2, wherein the machine learning system comprises:
a protocol determining artificial neural network configured to determine, for a scan study, a protocol name with which the scan study is to be designated.

17. The method of claim 6, further comprising:
generating representations for the standardized identifier codes based on weighted unigrams.

18. The method of claim 7, further comprising:
generating representations for the standardized identifier codes based on weighted unigrams.

19. The method of claim 8, wherein the refinement loop is iterated until an abort criterion is fulfilled, and wherein the abort criterion includes at least one of
a threshold number of labels has been obtained,
a threshold number of iterations has been performed, or
performing of the re-training of the machine learning system no longer improves significantly above a certain threshold or remains constant after a certain threshold.

20. An apparatus to train a machine learning system for mapping a scan study to a standardized identifier code of a standardized identifier code dictionary, the apparatus comprising:
a memory storing computer-readable instructions; and
at least one processor configured to execute the computer-readable instructions to cause the apparatus to
obtain a base set of scan studies,
classify, using a clustering algorithm, scan studies in the base set of scan studies, into a plurality of clusters,
select at least one scan study from each cluster among the plurality of clusters,
obtain standardized identifier code labels for the selected scan studies in order to generate a training set of labelled scan studies,
train a machine learning system, using the labelled scan studies to map individual scan studies to a corresponding standardized identifier code of the standardized identifier code dictionary, and
perform at least one refinement loop by
determining, based on an evaluation metric, an additional set of scan studies from the base set of scan studies,
obtaining standardized identifier code labels for scan studies in the additional set of scan studies in order to enlarge the training set of labelled scan studies, and
re-training the machine learning system, using at least the enlarged training set of labelled scan studies.
